(19) United States
(12) Patent Application Publication
(10) Pub. No.: US 2023/0084141 A1
(43) Pub. Date: Mar. 16, 2023

(54) Identifying Fluid Flow Paths in Naturally Fractured Reservoirs

(71) Applicant: Saudi Arabian Oil Company, Dhahran (SA)

(72) Inventors: Otto Meza Camargo, Dhahran (SA); Karla Olvera Carranza, Dhahran (SA); Marko Maucec, Dhahran (SA)

(21) Appl. No.: 17/476,914

(22) Filed: Sep. 16, 2021

(51) Int. Cl. G01V 99/00

(52) U.S. Cl. CPC G01V 99/005; G01V 2210/646

(57) ABSTRACT

Systems, methods, and computer readable media for the identification of fluid flow paths from the combination of aperture determined from microresistivity logs and mechanical properties from a mechanical earth model for a strike-slip fault regime. Fluid flow paths may be identified from a combination of apertures, shear stress, and normal stress for fractures in a naturally fractured hydrocarbon reservoir.

### BACKGROUND

### Field of the Disclosure

The present disclosure generally relates to the extraction of hydrocarbon (for example, oil and gas) resources. More specifically, embodiments of the disclosure relate to the identification of fluid flow paths in naturally fractured reservoirs.

### Description of the Related Art

The extraction of hydrocarbon resources from reservoirs in rock formations may depend on a variety of factors. In some instances, obtaining information about a hydrocarbon reservoir may be difficult due to the location and type of reservoir and associated formation. In particular, the identification of fluid flow paths in naturally fractured reservoirs (such as those associated with carbonate formations) may be challenging as numerous factors can affect the localization, distribution, and orientation of these fluid flow paths.

### SUMMARY

Fluid flow paths may be beneficial for field development by increasing and expediting the recovery factor; fluid flow paths may also be detrimental to field development by transporting water faster to well locations and reducing uniform sweep for hydrocarbon production. Additionally, certain fluid flow paths may negatively impact the performance of drilling operations by causing drilling fluid losses (for example, lost circulation), stuck pipes, or fluid flow canalization.

Embodiments of the disclosure include systems, methods, and computer readable media for the identification of fluid flow paths from the combination of aperture calculations determined from microresistivity logs and mechanical properties from a mechanical earth model for a strike-slip fault regime.

In one embodiment, a method for identifying fluid flow paths in a naturally fractured hydrocarbon reservoir is provide. The method includes determining an aperture of a fracture in the naturally fractured hydrocarbon reservoir using a resistivity, a drilling fluid resistivity, and an excess current measurement, and determining a shear stress associated with the fracture. The shear stress is determined from reservoir parameters representing properties of the hydrocarbon reservoir. The method also includes determining a normal stress associated with the fracture, such that the normal stress is determined from reservoir parameters representing properties of the hydrocarbon reservoir. The method further includes identifying a fluid flow path using the shear stress, the normal stress, and the aperture.

In some embodiments, identifying a fluid flow path includes identifying an orientation of the fluid flow path. In some embodiments, the reservoir parameters representing properties of the hydrocarbon reservoir include dynamic mechanical properties of the rock in the subsurface geological structure. In some embodiments, the reservoir parameters representing properties of the hydrocarbon reservoir include static mechanical properties of the rock in the subsurface geological structure. In some embodiments, the representing properties of the hydrocarbon reservoir include Young's modulus and Poisson's ratio. In some embodiments, the shear stress is further determined from fracture closing pressure (FCP). In some embodiments, resistivity is determined from a calibrated microresistivity log. In some embodiments, the calibrated microresisitivity includes a microresistivity log calibrated by a shallow openhole resistivity log.

In another embodiment, a non-transitory computer-readable storage medium having executable code stored thereon for identifying fluid flow paths in a naturally fractured hydrocarbon reservoir. The executable code includes a set of instructions that causes a processor to perform operations that include determining an aperture of a fracture in the naturally fractured hydrocarbon reservoir using a resistivity, a drilling fluid resistivity, and an excess current measurement, and determining a shear stress associated with the fracture. The shear stress is determined from reservoir parameters representing properties of the hydrocarbon reservoir. The operations also include determining a normal stress associated with the fracture, such that the normal stress is determined from reservoir parameters representing properties of the hydrocarbon reservoir. The operations further include identifying a fluid flow path using the shear stress, the normal stress, and the aperture.

In some embodiments, identifying a fluid flow path includes identifying an orientation of the fluid flow path. In some embodiments, the reservoir parameters representing properties of the hydrocarbon reservoir include dynamic mechanical properties of the rock in the subsurface geological structure. In some embodiments, the reservoir parameters representing properties of the hydrocarbon reservoir include static mechanical properties of the rock in the subsurface geological structure. In some embodiments, the representing properties of the hydrocarbon reservoir include Young's modulus and Poisson's ratio. In some embodiments, the shear stress is further determined from fracture closing pressure (FCP).

In another embodiment, a system for identifying fluid flow paths in a naturally fractured hydrocarbon reservoir is provided. The system includes a process and a non-transitory computer-readable memory accessible by the processor and having executable code stored thereon. The executable code includes a set of instructions that causes a processor to perform operations that include determining an aperture of a fracture in the naturally fractured hydrocarbon reservoir using a resistivity, a drilling fluid resistivity, and an excess current measurement, and determining a shear stress associated with the fracture. The shear stress is determined from reservoir parameters representing properties of the hydrocarbon reservoir. The operations also include determining a normal stress associated with the fracture, such that the normal stress is determined from reservoir parameters representing properties of the hydrocarbon reservoir. The operations further include identifying a fluid flow path using the shear stress, the normal stress, and the aperture.

In some embodiments, identifying a fluid flow path includes identifying an orientation of the fluid flow path. In some embodiments, the reservoir parameters representing properties of the hydrocarbon reservoir include dynamic mechanical properties of the rock in the subsurface geological structure. In some embodiments, the reservoir parameters representing properties of the hydrocarbon reservoir include static mechanical properties of the rock in the subsurface geological structure. In some embodiments, the representing properties of the hydrocarbon reservoir include Young's modulus and Poisson's ratio. In some embodiments, the shear stress is further determined from fracture closing pressure (FCP). In some embodiments, resistivity is determined form a calibrated microresistivity log. In some embodiments, the calibrated microresistivity includes a microresistivity log calibrated by a shallow openhole resistivity log.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a process for identifying fluid flow paths in accordance with an embodiment of the disclosure;

FIG. 2 is a static equalized image and a dynamic equalized image illustrating the verification of a fracture in accordance with an embodiment of the disclosure;

FIG. 3 is a plot of example histogram curves between microresistivity image arrays and shallow openhole resistivity logs in accordance with an embodiment of the disclosure;

FIG. 4 depicts images from microresistivity logs illustrating fracture aperture as sinusoids along fracture planes in accordance with an embodiment of the disclosure; and

FIG. 5 depicts an example Schmidt projection showing two fracture sets' orientation colored by aperture values in accordance with an embodiment of the disclosure;

FIG. 6 depicts a composite log showing a comparison between the mechanical properties calculated from sonic logs with the mechanical properties determined from laboratory calculations in accordance with an embodiment of the disclosure;

FIG. 7 is a plot of true vertical depth vs vertical stress gradient (in mud weight equivalent of pounds per gallon (ppg)) that shows a vertical stress calculation using a compaction line and bulk density in accordance with an embodiment of the disclosure;

FIG. 8 is a plot 800 true vertical depth vs a minimum horizontal stress gradient (expressed in pounds per cubic foot (PCF)) that shows a minimum horizontal stress (Sₕₘᵢₙ) calculation in accordance with an embodiment of the disclosure;

FIG. 9A depicts a composite log showing the stress profiles and wellbore stability in accordance with an embodiment of the disclosure;

FIG. 9B shows a breakouts orientation for a section of the borehole depicted in FIG. 9A;

FIG. 9C shows a close-up of the borehole section depicted in FIG. 9A;

FIG. 10 is a schematic diagram of components of a stress vector in accordance with an embodiment of the disclosure;

FIG. 11A is a diagram illustrating fluid flow paths for hydraulically conductive and non-hydraulically conductive fractures using normal stresses in accordance with an embodiment of the disclosure;

FIG. 11B is a Mohr circle plot of shear stress vs normal stress and coefficient of friction in accordance with an embodiment of the disclosure;

FIG. 12A is a plot of shear stress vs effective normal stress for each fracture plane in accordance with an embodiment of the disclosure;

FIG. 12B is a corresponding Schmidt projection that shows the orientation of critically stressed fractures of FIG. 12A in accordance with an embodiment of the disclosure; and

FIG. 13 is a block diagram of a data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

As discussed below, embodiments of the disclosure include the identification of fluid flow paths from fracture apertures determined from microresistivity logs and mechanical properties (that is, shear stress and normal stress) from a mechanical earth model for a strike-slip fault regime. As known in the art, the term “fracture aperture” refers to a perpendicular width of an open fracture.

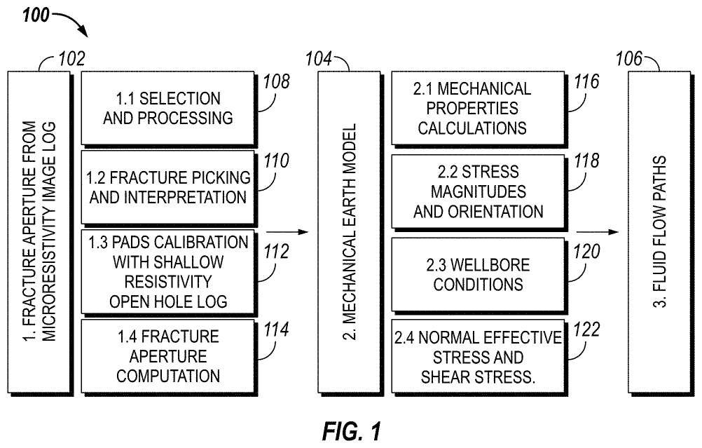

FIG. 1 depicts a process 100 for identifying fluid flow paths in accordance with an embodiment of the disclosure. As shown in FIG. 1, the process 100 may include: 1) determining fracture aperture from microresistivity logs (block 102); 2) determining normal and shear stress from a mechanical earth model (block 104); and 3) identifying fluid flow paths for a strike-slip fault regime (block 106).

As also shown in FIG. 1, determining fracture aperture from microresistivity logs may include the selecting and processing microresistivity logs using known microresistivity tools (block 108), interpreting and picking fractures from static and dynamic equalized images from the microresistivity logs (block 110), calibrating microresistivity arrays versus shallow resistivity openhole logs (block 112) and calculating fracture aperture from calibrated microresistivity arrays, fracture dataset, shallow resistivity, and mud resistivity (block 114).

Determining normal and shear stress from a mechanical earth mode may include calculating mechanical properties (block 116), determining stress magnitude and orientation (block 118), evaluating wellbore conditions such as wellbore stability (block 120), and determining normal effective stress and shear stress (block 122).

As mentioned infra, the fracture aperture may be determined from microresistivity logs. As will be appreciated, the microresistivity logs may be obtained from a wireline logging tool having a microresistivity measuring device. In some embodiments, the microresistivity logs may be obtained from one well. In other embodiments, microresistivity logs may be obtained from multiple wells so that the aperture determination provides a field-scale aperture trends analysis. In some embodiments, the microresistivity logs may be obtained using the Fullbore Formation Microimager manufactured by Schlumberger Limited of Houston, Tex., USA. In other embodiments, the microresistivity logs may be obtained using the Formation Microscanner manufactured by Schlumberger Limited of Houston, Tex., USA. As will be appreciated, embodiments using one of these tools may use a water-based drilling mud during drilling.

Initially, the microresistivity logs are evaluated (block 108) to verify that a number of natural fractures are detected to provide a sufficient sample size. In some embodiments, at least two sets (that is, two different groups) of natural fractures is sufficient. The evaluation may include selecting and discarding entire microresistivity logs or portions of microresistivity logs. The selection may include discarding microresistivity logs that have oversaturated resistivity measurements, large standoffs, or dead buttons.

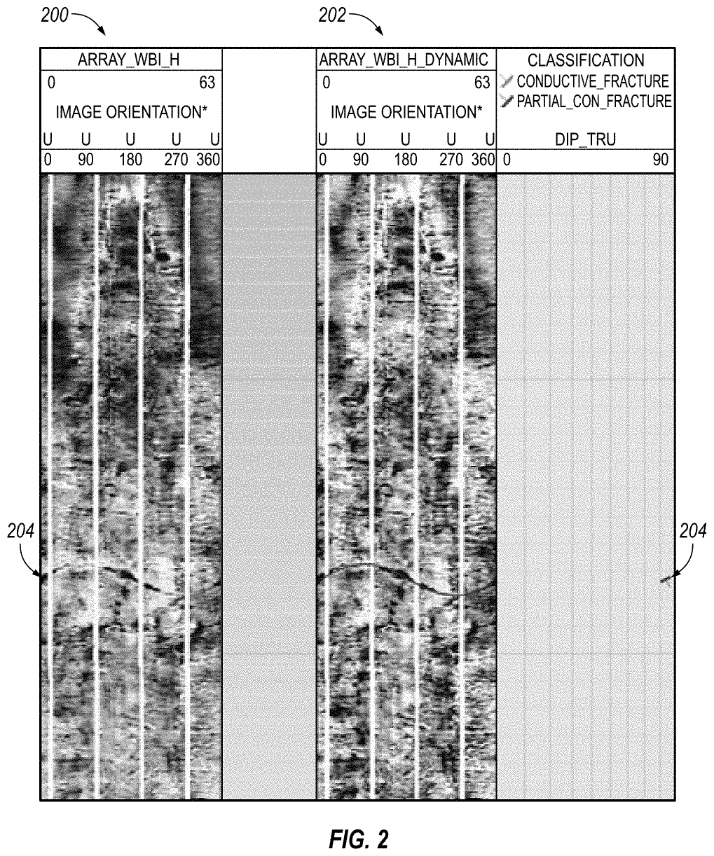

Next, fractures may be picked and interpreted (block 110) from static and dynamic equalized images from the microresistivity logs. After the picking and interpretation, a duplicated fracture dataset having the picked fractures may be used to verify that the fractures exhibit continuity, strong conductivity contrasts against the rock matrix, and regular fracture walls or other boundaries. FIG. 2 depicts a static equalized image 200 and a dynamic equalized image 202 illustrating the verification of a fracture 204.

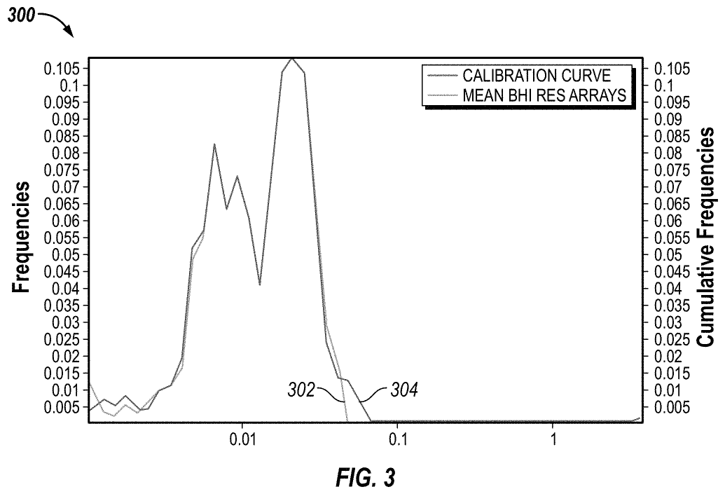

The microresistivity speed corrected arrays may then be calibrated against shallow openhole resistivity logs (block 112). The calibration may be performed using a series of linear regressions over the response range of the input data between the calibration variable and the mean value of the input microresistivity arrays. The calibration may then be adjusted to obtain a suitable match between the two inputs. FIG. 3 is a plot 300 of example histogram curves between microresistivity image arrays (curve 302) and shallow openhole resistivity logs (curve 304) showing a match after calibration. In some embodiments, the calibration may be performed using the Techlog Wellbore Software Platform manufactured by Schlumberger Limited of Houston, Tex., USA.

The fracture apertures may be determined from the calibrated microresistivity arrays, the fracture dataset, shallow resistivity, and drilling mud resistivity. The fracture aperture determination may be performed using Equation 1:

W=cA Rₘ^{b}Rₓₒ^{1-b} (1)

where W is the fracture width (that is, aperture), Rxo is the flushed zone resistivity, Rm is the mud resistivity, and A is the excess current flowing into the rock matrix through the conductive media due to the presence of the fracture. The excess current is a function of the fracture width and may be determined from statistical and geometrical analysis of the anomaly it creates as compared to background conductivity. For example, the excess current may be determined by dividing by voltage and integrating along a line perpendicular to the fracture trace. The term c is a constant and b is numerically obtained tool-specific parameter (that is, specific to the resistivity tools). As will be appreciated, a greater fracture aperture (W) indicates a more open fracture that is likely to flow hydrocarbons or other fluids, and a lesser fracture aperture indicates a fracture that will likely have reduced or low flow to hydrocarbons or other fluids.

The determined fracture aperture mean values may be provided in two forms: as sinusoids along fractures and as a secondary track with the mean value points. In addition to the mean fracture aperture, the hydraulic mean fracture aperture may be determined using Equation 2:

$$FVAH = \sqrt[3]{\frac{\sum ( length \times {aperture}^{3} )}{Total Length}} \qquad ( 2 )$$

where FVAH is the hydraulic mean fracture aperture.

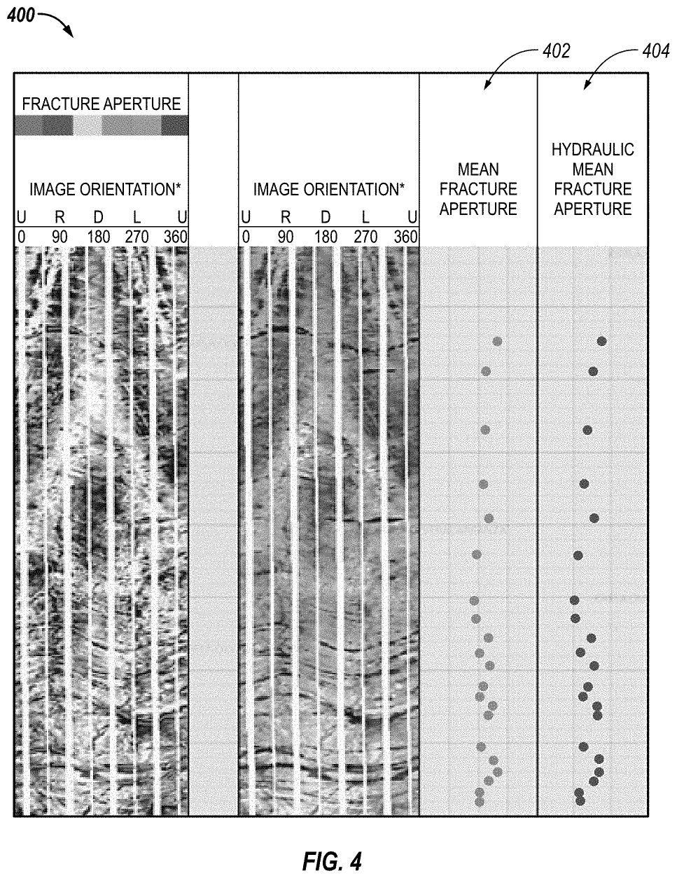

FIG. 4 depicts images 400 from microresistivity logs illustrating fracture aperture as sinusoids 402 along fracture planes in accordance with an embodiment of the disclosure. FIG. 4 also depicts points 404 for the mean fracture aperture, and points 406 for the hydraulic mean fracture aperture.

In some embodiments, the determined sinusoids may be evaluated to determine that they align with the fracture planes. In such embodiments, aperture sinusoids outside of the fracture walls may be removed from the dataset to produce a clean fracture dataset, and the aperture calculation may be performed again using the clean fracture dataset.

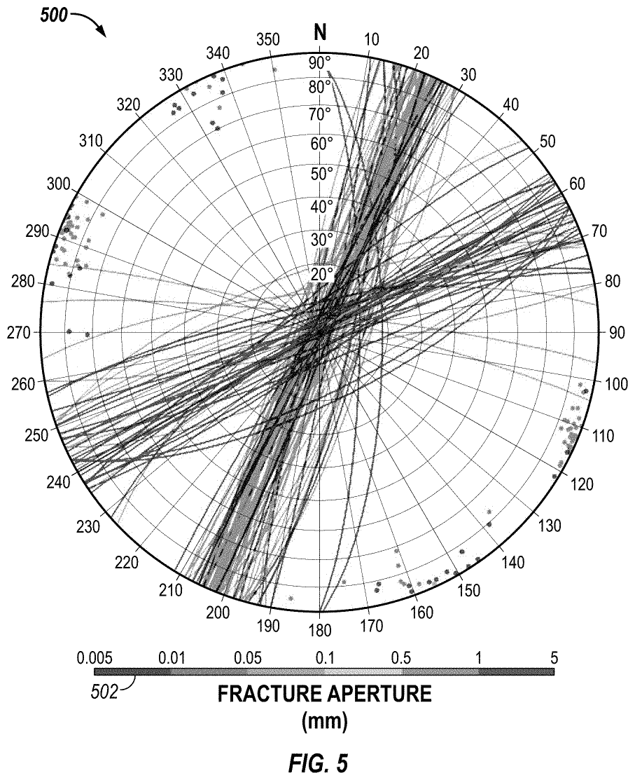

In some embodiments fracture planes may be colored using a color palette based on aperture values and displayed using a Schmidt projection to visualize different aperture values for different fracture datasets. FIG. 5 depicts an example Schmidt projection 500 showing two fracture sets' orientation colored by aperture values in accordance with an embodiment of the disclosure. As shown in FIG. 5, the different aperture values may be differentiated using the different colors for aperture values as shown in the legend 502.

In some embodiments, the mechanical earth model may be implemented according to the techniques described in U.S. patent application Ser. No. 16/792,742 filed Feb. 17, 2020, and titled “DETERMINATION OF CALIBRATED MINIMUM HORIZONTAL STRESS MAGNITUDE USING FRACTURE CLOSURE PRESSURE AND MULTIPLE MECHANICAL EARTH MODEL REALIZATIONS,” now issued U.S. Pat. No. 11,098,582, a copy of which is incorporated by reference in its entirety.

As discussed in the disclosure, normal and shear stress for a reservoir having the determined apertures may be determined from a mechanical earth model. Initially, mechanical properties for rock formation may be determined (block 116). The mechanical properties may include static rock mechanical properties and dynamic rock mechanical properties. Static rock mechanical properties may be determined through static rock mechanical properties testing of rock samples. The rock samples may include core plugs with precise dimensions and conditions. In some embodiments, the tests of rock samples may include uniaxial core tests to determine rock stress-strain relations as functions of formation rock as functions of applied tensile or compressive loads. In some embodiments, the tests of rock samples may include single or multi-stage tri-axial rock mechanical tests to provide data representing measures rock strength and mechanical conditions to simulate in-situ stress conditions providing compressive strength and static values of elastic constants of the rock.

The static rock mechanical properties may include static Young's modulus. As known in the art, the static Young's modulus may be determined from the slope

$$\frac{Δ σ}{Δ ε a}$$

or a specific portion (50% peak stress) of a stress-strain curve of stress-strain ratio E. The stress-strain ratio E of a rock sample may be determined as the ratio of axial stress (Δσ) and axial strain (Δεα). The static rock mechanical properties may also include Poisson's ratio. The Poisson's ratio the negative of the ratio of transverse strain to the axial strain in an elastic material subjected to a uniaxial stress and may be determined from the slope

$$\frac{{ε}_{r}}{ε a}$$

of a specific portion of a radial strain-axial strain curve.

The dynamic rock mechanical properties may include, for example, dynamic Young modulus, shear modulus, and bulk modulus, and Poisson's ratio. In some embodiments, dynamic rock mechanical properties may be determined from compressional sonic logs, shear sonic logs, and density logs obtained from well logging tools.

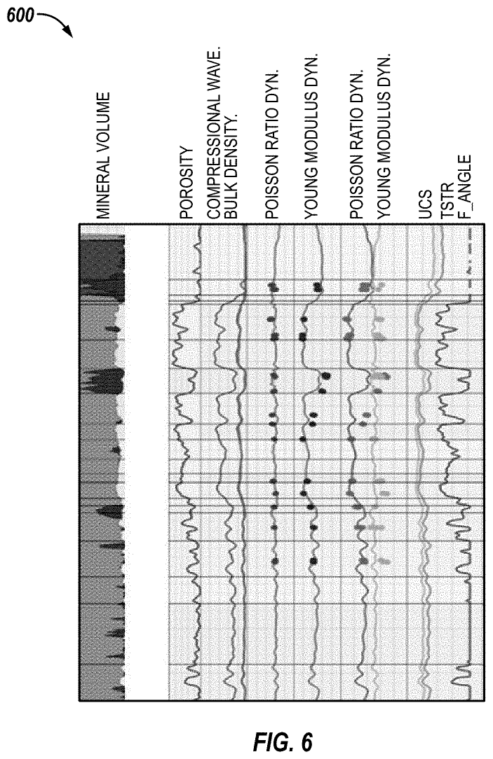

A relationship may be determined between the status Young's modulus (YMS) and dynamic Young modulus (YMD) and other properties for a comparison. FIG. 6 is a composite log 600 showing a comparison between the mechanical properties calculated from sonic logs with the mechanical properties determined from laboratory calculations in accordance with an embodiment of the disclosure.

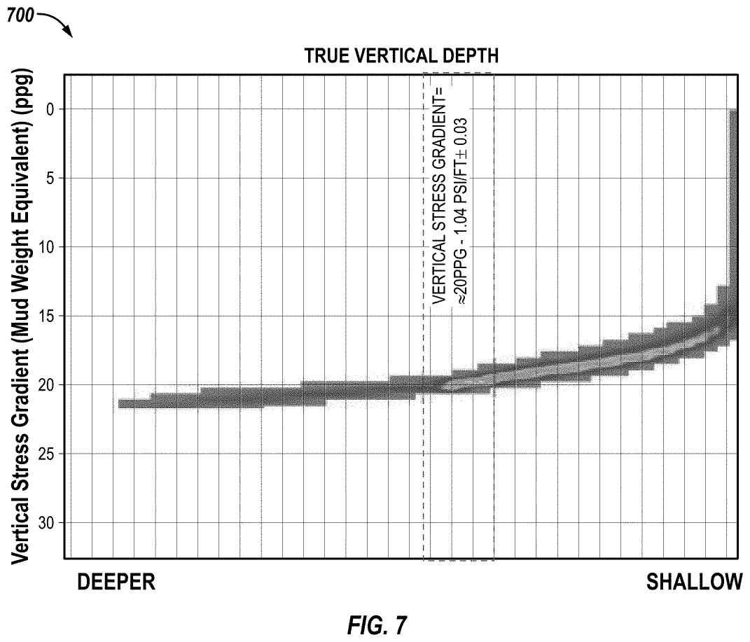

Next, the stress magnitude and orientation for the mechanical earth model may be determined (block 116). The overburden (that is, vertical stress (Sᵥ)) may be calculated from bulk density logs and a compaction line technique. The vertical stress (Sᵥ) is the intermediate principal stress in a slip-strike regime. By way of example, FIG. 7 is a plot 700 of true vertical depth vs vertical stress gradient (in mud weight equivalent of pounds per gallon (ppg)) that shows a vertical stress calculation using a compaction line and bulk density in accordance with an embodiment of the disclosure. As shown in the example depicted in FIG. 7, the vertical stress gradient is approximately 1.04 pounds per square inch (psi) per foot (ft).

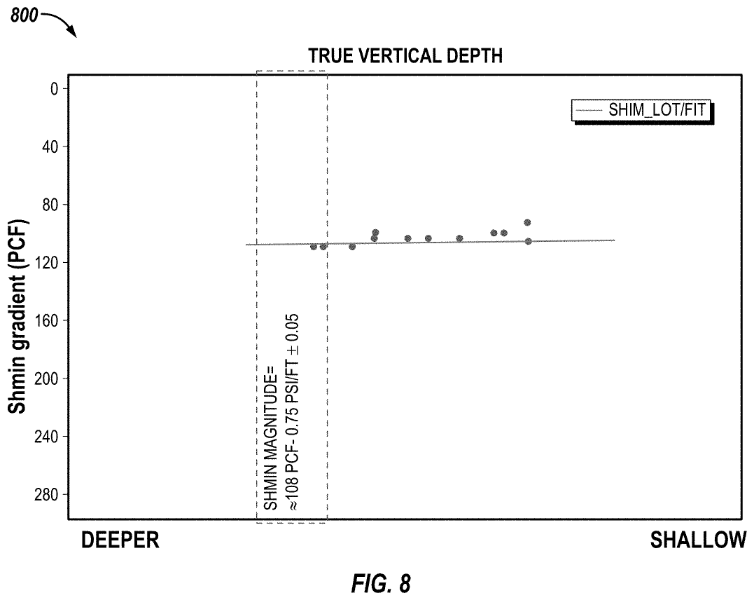

The minimum horizontal stress (Sₕₘᵢₙ) may be calculated from fracture closure pressure (such as determined by a leak-off test (LOT)). By way of example, FIG. 8 is a plot 800 of true vertical depth vs a minimum horizontal stress gradient (expressed in pounds per cubic foot (PCF)) that shows a minimum horizontal stress (Sₕₘᵢₙ) calculation in accordance with an embodiment of the disclosure. In the example shown in FIG. 8, the minimum horizontal stress is approximately 0.75 psi/ft pounds per square inch (psi) per foot (ft).

The maximum horizontal stress (S_{Hmax}) may be determined by assuming a strike-slip fault regime wherein the maximum horizontal stress (S_{Hmax}) is the largest principal stress (that is, S_{Hmax}>Sᵥ>Sₕₘᵢₙ). The orientation of the maximum horizontal stress may be determined using wellbore failure analysis such as borehole breakouts and drilling-induced tensile fractures interpreted from a borehole image (BHI) log.

A minimum horizontal stress (Sₕₘᵢₙ) and maximum horizontal stress (S_{Hmax}) profile may be determine using a poro-elastic and horizontal-strain stress approach, wherein the minimum horizontal stresses and maximum horizontal stresses at each depth depend on the following factors: 1) mechanical properties; 2) pore pressure; and 3) vertical stress (overburden). The pore pressure may be determined from direct measurements using MDT (Modular Formation Dynamics) and Bottom Hole Static Pressure (BHSP) as known in the art. The maximum horizontal stress (S_{Hmax}) may also be constrained by using wellbore stability model and drilling events (for example, mud lost circulation, stuck pipes, in-flow, and tight hole).

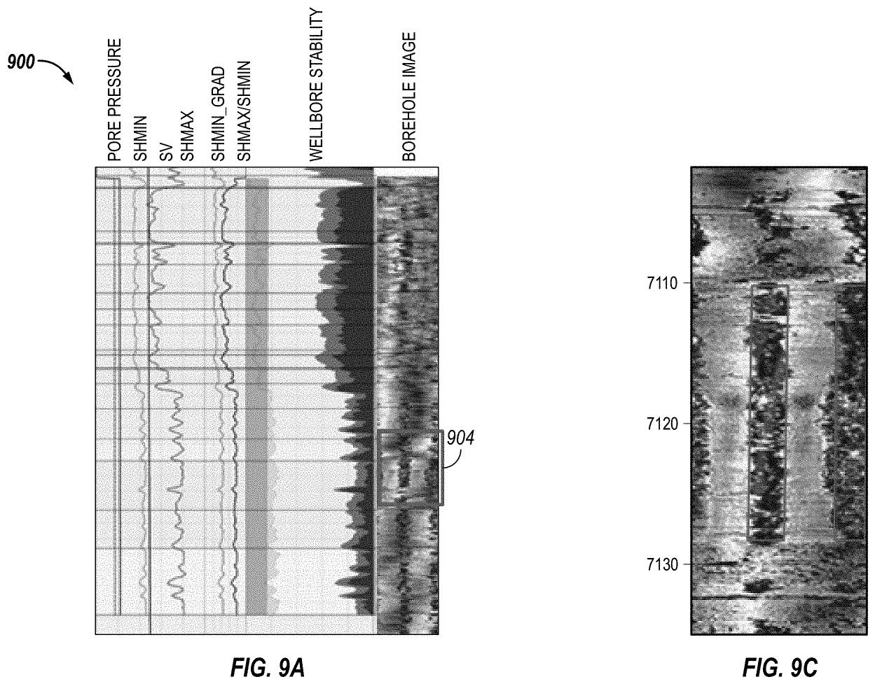

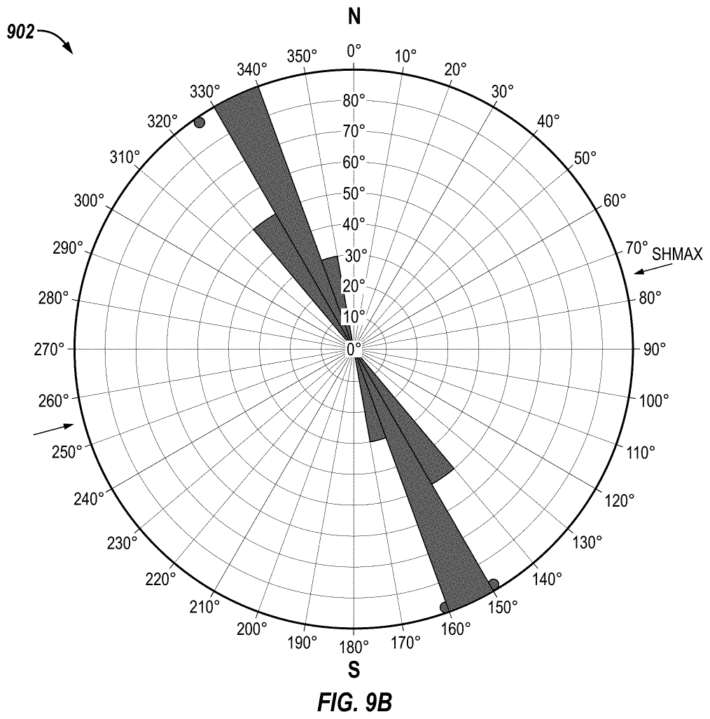

Next, wellbore stability conditions may be evaluated through the qualitative and quantitative match using mechanical failures (such as breakouts and drilling tensile fractures) interpreted from the borehole image (BHI) log. The evaluation may capture the interaction between the drilling mud weight, breakout pressure, and breakdown pressure. FIG. 9A depicts a composite log 900 showing the stress profiles and wellbore stability in accordance with an embodiment of the disclosure. FIG. 9B shows a breakouts orientation 902 for a section 904 of the borehole. FIG. 9C further shows a close-up of the borehole section 904.

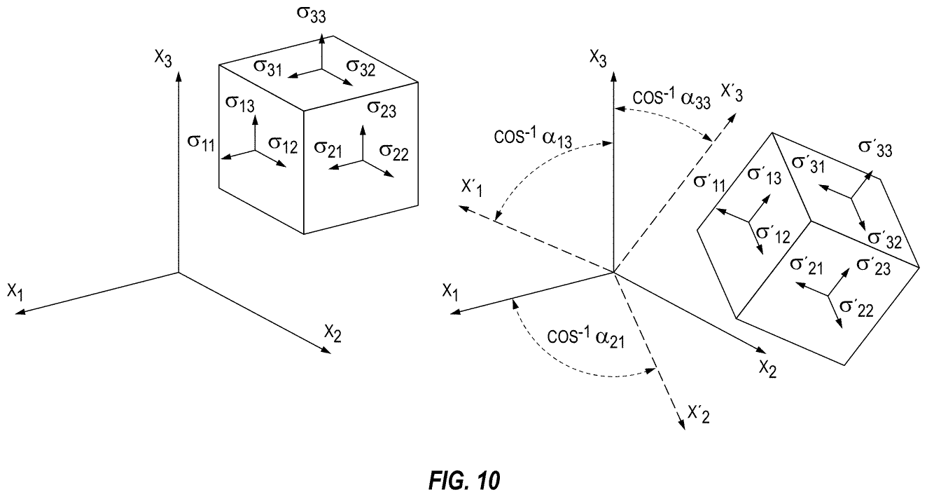

As discussed in the disclosure, normal effective stress and shear stress may be determined (block 122). FIG. 10 is a schematic diagram of the stress components of a stress vector. As shown in FIG. 10, normal effective stress (σₙ) component of any stress vector T⁽ⁿ⁾ which is acting over an arbitrary fracture plane with a normal unit vector n at a given point. In terms of stress tensor components σ_{i,j} the normal stress may be defined as the product of stress vector multiplied by normal unit vector σₙ=T⁽ⁿ⁾.n and the magnitude of the shear stress (τₙ) component as defined in Equation 3:

τₙ=\sqrt{(T⁽ⁿ⁾)²−σₙ} (3)

A fluid flow path may be determined from shear stress and normal effective stress as shown in Equation 3:

Fluid flow path=(τ−σₙ*Tan(φ)≥0 (4)

Where τ is the shear stress, σₙ is the effective normal stress, and φ is the friction angle.

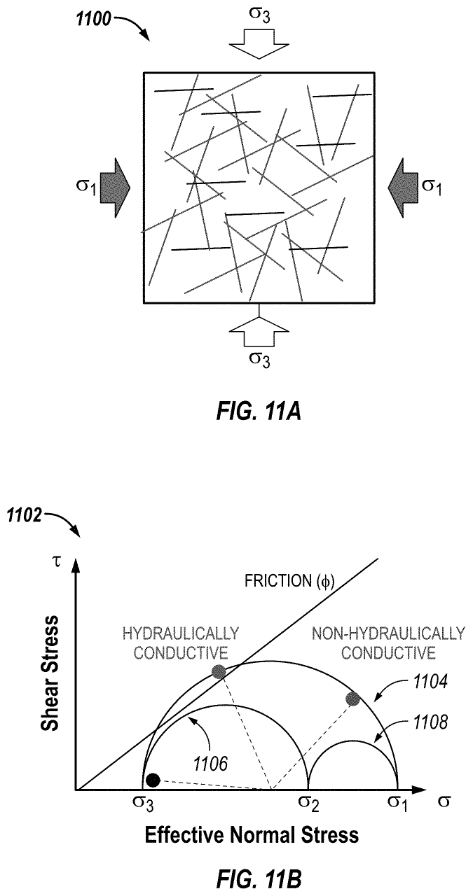

As will be appreciated, critical stress depends on the stress magnitude and the orientation of the fracture plane with respect to the in situ stress orientation. The stress orientation affects the normal and shear stresses acting in the fracture plane. When normal and shear stress exceed the friction angle (for non-intact rock), the shearing may produce dilation that keeps the fracture hydraulically open. Fractures in this state may be referred to as “reactivated” or “critically stressed.” FIG. 11A is a diagram 1100 illustrating fluid flow paths for hydraulically conductive and non-hydraulically conductive fractures using normal stresses (σ₁ and σ₃) in accordance with an embodiment of the disclosure. FIG. 11B is a plot 1102 of shear stress vs normal stress and coefficient of friction in accordance with an embodiment of the disclosure. FIG. 11B illustrates “Mohr circles” 1104, 1106, and 1108, as is known in the art.

Shear failure may be caused by two perpendicular stresses acting on the same plane, and is defined in conjunction with a Mohr circle by the following equation expressing stress conditions shown schematically in FIG. 11B:

σ1′≥C0+σ3′ tan 2β (5)

Where C0 is the unconfined compressive strength, σ1′ is the maximum effective stress, σ3′ is the minimum effective stress, and β is the angle between the normal stress and the maximum effective stress σ1′, such is β is determined as follows:

$$β = 45 ° + \frac{Φ}{2} \qquad ( 6 )$$

Wherein ϕ is the friction angle.

If the maximum effective stress σ1′ is exceeded, then the conditions for shear failure are satisfied.

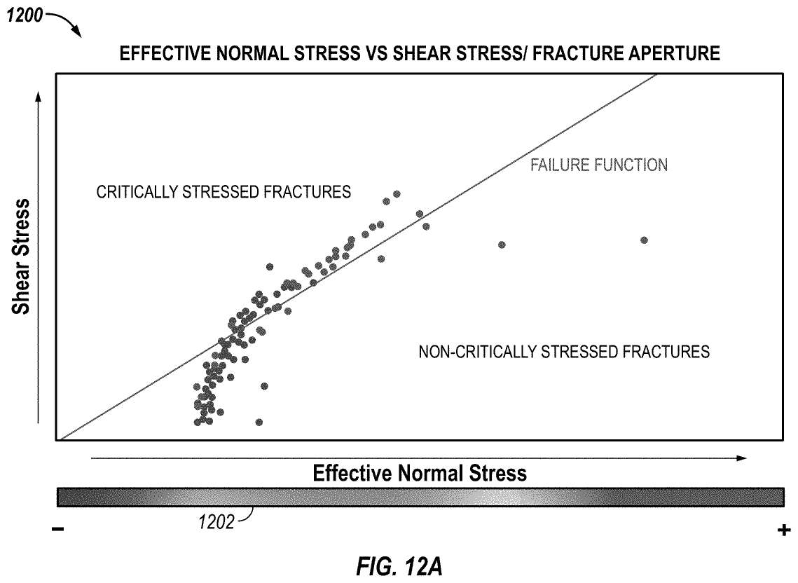

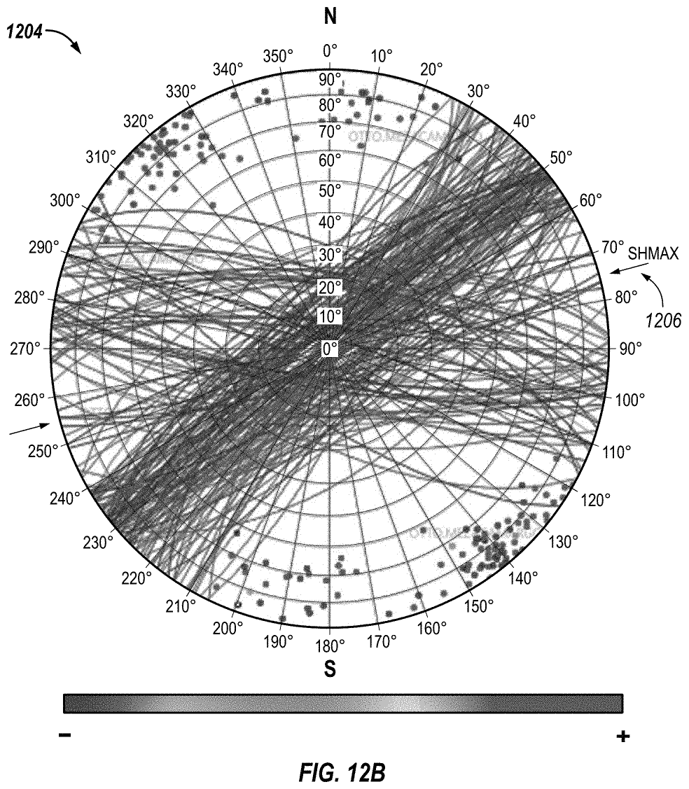

Accordingly, fluid flow paths for a fracture network in a rock matrix may be identified by using the determined apertures combined with the normal effective stress and shear stress. The largest aperture corresponds to the greatest distance between the points and the failure Mohr Coulomb line (that is, the friction angle for non-intact rock). By way of example, FIG. 12A is a plot 1200 of shear stress vs effective normal stress for each fracture plane and that shows the Mohr Coulomb line and the critically stressed fractures (above the line) and non-critically stressed fractures (below the line) in accordance with an embodiment of the disclosure. As shown in FIG. 12A, fractures with greater mean apertures (that is, red according to the color legend 1202) are relatively close to or above the failure function line. Thus, they represent the most relevant fluid paths (red according to the color legend 1202). FIG. 12B is a corresponding Schmidt projection 1204 that shows the orientation of critically stressed fractures of FIG. 12A, with arrows 1206 showing the point of maximum horizontal stress (S_{Hmax}) and the color legend corresponding to mean hydraulic fracture aperture in accordance with an embodiment of the disclosure.

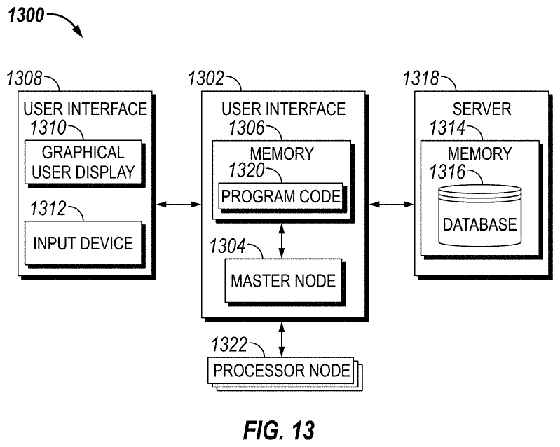

FIG. 13 depicts a data processing system 1300 that includes a computer 1302 having a master node processor 1304 and memory 1306 coupled to the processor 1304 to store operating instructions, control information and database records therein. The data processing system 1300 may be a multicore processor with nodes such as those from Intel Corporation or Advanced Micro Devices (AMD), or an HPC Linux cluster computer. The data processing system 1300 may also be a mainframe computer of any conventional type of suitable processing capacity such as those available from International Business Machines (IBM) of Armonk, N.Y. or other source. The data processing system 1300 may in cases also be a computer of any conventional type of suitable processing capacity, such as a personal computer, laptop computer, or any other suitable processing apparatus. It should thus be understood that a number of commercially available data processing systems and types of computers may be used for this purpose

The computer 1302 is accessible to operators or users through user interface 1308 and are available for displaying output data or records of processing results obtained according to the present disclosure with an output graphic user display 1310. The output display 1310 includes components such as a printer and an output display screen capable of providing printed output information or visible displays in the form of graphs, data sheets, graphical images, data plots and the like as output records or images.

The user interface 1308 of computer 1302 also includes a suitable user input device or input/output control unit 1312 to provide a user access to control or access information and database records and operate the computer 1302. Data processing system 1300 further includes a database of data stored in computer memory, which may be internal memory 1306, or an external, networked, or non-networked memory as indicated at 1314 in an associated database 1316 in a server 1318.

The data processing system 1300 includes executable code 1320 stored in non-transitory memory 224 of the computer 1302. The executable code 1320 according to the present disclosure is in the form of computer operable instructions causing the data processor 1304 to determine apertures of fractures, vertical stress, maximum horizontal stress, minimum horizontal stress, shear stress, normal stress and identify fluid flow paths according to the present disclosure in the manner set forth.

It should be noted that executable code 1320 may be in the form of microcode, programs, routines, or symbolic computer operable languages capable of providing a specific set of ordered operations controlling the functioning of the data processing system 1300 and direct its operation. The instructions of executable code 1320 may be stored in memory 1306 of the data processing system 1300, or on computer diskette, magnetic tape, conventional hard disk drive, electronic read-only memory, optical storage device, or other appropriate data storage device having a non-transitory computer readable storage medium stored thereon. Executable code 1320 may also be contained on a data storage device such as server 1318 as a non-transitory computer readable storage medium, as shown.

The data processing system 1300 may be comprised of a single CPU, or a computer cluster as shown in FIG. 13, including computer memory and other hardware to make it possible to manipulate data and obtain output data from input data. A cluster is a collection of computers, referred to as nodes, connected via a network. Usually a cluster has one or two head nodes or master nodes 1304 used to synchronize the activities of the other nodes, referred to as processing nodes 1322. The processing nodes 1322 each execute the same computer program and work independently on different segments of the grid which represents the reservoir.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for identifying fluid flow paths in a naturally fractured hydrocarbon reservoir, the method comprising:
determining an aperture of a fracture in the naturally fractured hydrocarbon reservoir using a resistivity, a drilling fluid resistivity, and an excess current measurement;
determining a shear stress associated with the fracture, the shear stress determined from reservoir parameters representing properties of the hydrocarbon reservoir;
determining a normal stress associated with the fracture, the normal stress determined from reservoir parameters representing properties of the hydrocarbon reservoir; and
identifying a fluid flow path using the shear stress, the normal stress, and the aperture.

2. The method of claim 1, wherein identifying a fluid flow path comprises identifying an orientation of the fluid flow path.

3. The method of claim 1, wherein the reservoir parameters representing properties of the hydrocarbon reservoir comprise dynamic mechanical properties of the rock in the subsurface geological structure.

4. The method of claim 1, wherein the reservoir parameters representing properties of the hydrocarbon reservoir comprise static mechanical properties of the rock in the subsurface geological structure.

5. The method of claim 1, wherein the representing properties of the hydrocarbon reservoir comprise Young's modulus and Poisson's ratio.

6. The method of claim 1, wherein the shear stress is further determined from fracture closing pressure (FCP).

7. The method of claim 1, wherein resistivity is determined from a calibrated microresistivity log.

8. The method of claim 6, wherein the calibrated microresisitivity comprises a microresistivity log calibrated by a shallow openhole resistivity log.

9. A non-transitory computer-readable storage medium having executable code stored thereon for identifying fluid flow paths in a naturally fractured hydrocarbon reservoir, the executable code comprising a set of instructions that causes a processor to perform operations comprising:
determining an aperture of a fracture in the naturally fractured hydrocarbon reservoir using a resistivity, a drilling fluid resistivity, and an excess current measurement;
determining a shear stress associated with the fracture, the shear stress determined from reservoir parameters representing properties of the hydrocarbon reservoir;
determining a normal stress associated with the fracture, the normal stress determined from reservoir parameters representing properties of the hydrocarbon reservoir; and
identifying a fluid flow path using the shear stress, the normal stress, and the aperture.

10. The non-transitory computer-readable storage medium of claim 9, wherein identifying a fluid flow path comprises identifying an orientation of the fluid flow path.

11. The non-transitory computer-readable storage medium of claim 9, wherein the reservoir parameters representing properties of the hydrocarbon reservoir comprise dynamic mechanical properties of the rock in the subsurface geological structure

12. The non-transitory computer-readable storage medium of claim 9, wherein the reservoir parameters representing properties of the hydrocarbon reservoir comprise static mechanical properties of the rock in the subsurface geological structure.

13. The non-transitory computer-readable storage medium of claim 9, wherein the shear stress is further determined from fracture closing pressure (FCP).

14. A system for identifying fluid flow paths in a naturally fractured hydrocarbon reservoir, comprising
a processor;
non-transitory computer-readable memory accessible by the processor and having executable code stored thereon, the executable code comprising a set of instructions that causes a processor to perform operations comprising:
determining an aperture of a fracture in the naturally fractured hydrocarbon reservoir using a resistivity, a drilling fluid resistivity, and an excess current measurement;
determining a shear stress associated with the fracture, the shear stress determined from reservoir parameters representing properties of the hydrocarbon reservoir;
determining a normal stress associated with the fracture, the normal stress determined from reservoir parameters representing properties of the hydrocarbon reservoir; and
identifying a fluid flow path using the shear stress, the normal stress, and the aperture.

15. The system of claim 14, wherein identifying a fluid flow path comprises identifying an orientation of the fluid flow path.

16. The system of claim 14, wherein the reservoir parameters representing properties of the hydrocarbon reservoir comprise dynamic mechanical properties of the rock in the subsurface geological structure

17. The system of claim 14, wherein the reservoir parameters representing properties of the hydrocarbon reservoir comprise static mechanical properties of the rock in the subsurface geological structure.

18. The system of claim 14, wherein the shear stress is further determined from fracture closing pressure (FCP).

19. The system of claim 14, wherein resistivity is determined from a calibrated microresistivity log.

20. The system of claim 19, wherein the calibrated microresisitivity comprises a microresistivity log calibrated by a shallow openhole resistivity log.
